(19) United States
(12) Patent Application Publication
(10) Pub. No.: US 2024/0303545 A1
(43) Pub. Date: Sep. 12, 2024

(54) LEARNING DEVICE, DATA AUGMENTATION SYSTEM, ESTIMATION DEVICE, LEARNING METHOD, AND RECORDING MEDIUM

(71) Applicant: NEC Corporation, Tokyo (JP)

(72) Inventors: Kenichiro FUKUSHI, Tokyo (JP); Yoshitaka Nozaki, Tokyo (JP); Kosuke Nishihara, Tokyo (JP); Kentaro Nakahara, Tokyo (JP)

(73) Assignee: NEC Corporation, Tokyo (JP)

(21) Appl. No.: 18/586,697

(22) Filed: Feb. 26, 2024

(30) Foreign Application Priority Data
Mar. 10, 2023 (JP) 2023-037407

(51) Int. Cl. G06N 20/00

(52) U.S. Cl. CPC G06N 20/00

(57) ABSTRACT

Provided is a learning device including a data acquisition unit that acquires a data set including a plurality of training data, a generation unit that includes a generation model that outputs pseudo data, a discrimination unit that includes a discrimination model that discriminates whether the input data is either the training data or the pseudo data according to an input of either the training data or the pseudo data, a management unit that sets a first hyperparameter to be used for updating the discrimination model based on a preset hyperparameter, and a second hyperparameter to be used for updating the generation model, and a learning processing unit that updates the discrimination model using the first hyperparameter and updates the generation model using the second hyperparameter.

This application is based upon and claims the benefit of priority from Japanese Patent Application No. 2023-037407, filed on Mar. 10, 2023, the disclosure of which is incorporated herein in its entirety by reference.

### TECHNICAL FIELD

The present disclosure relates to a learning device, a data augmentation system, an estimation device, a learning method, and a recording medium.

### BACKGROUND ART

Techniques for sensing a motion of a person using a video, motion capture, or a wearable sensor and recognizing a motion or an action according to the sensed motion are attracting attention. For example, by using a recognition model in which motion data is learned by a method such as machine learning, a motion or an action of a person can be recognized. To perform recognition with more practical accuracy, it is necessary to train a recognition model using a large amount of motion data. For example, it is necessary to train a recognition model using training data including variations regarding physiques, ages, motion habits for each individual, and the like regarding motions of various persons. Measurement of motion data takes a lot of time and effort. Therefore, a data augmentation technique for generating a large amount of pseudo data (pseudo motion data) of actually measured motion data is required.

Distributed learning, which performs large-scale parallel processing using multiple graphics processing units (GPUs) and computational nodes, is one method for training models at high speed using Generative Adversarial Network (GAN). In distributed learning, calculation processing is divided by a plurality of GPUs to shorten the calculation processing. By increasing the number of GPUs by k times, the amount of data that can be processed at once (batch size) increases by k times. (k is a natural number). However, in practice, the learning cannot be speeded up only by increasing the batch size.

NPL 1 (P. Goyal. et al., “Accurate, Large Minibatch SGD: Training ImageNet in 1 Hour,” arXiv: 1706.02677, 2018) discloses a technique for improving the efficiency of learning in distributed learning. In the method of NPL 1, a technique of adjusting a learning rate according to a scale of distributed learning is disclosed. In the method of NPL 1, the learning rate is increased in proportion to the batch size.

According to the method of NPL 1, the batch size is sufficiently small compared to the dataset size, and model training can be made more efficient. In a large-scale distributed learning environment, a precondition of a linear scaling rule is not satisfied because a batch size exceeds a data set size. Therefore, the method of NPL 1 cannot be applied to a large-scale distributed learning environment. That is, in the method of NPL 1, the minority shot learning (few-shot learning) of the GAN cannot be made to correspond to the large-scale parallel processing.

An object of the present disclosure is to provide a learning device and the like capable of speeding up minority shot learning of a GAN (Generative Adversarial Network) in a large-scale distributed learning environment.

### SUMMARY

A learning device according to one aspect of the present disclosure includes a data acquisition unit that acquires a data set including a plurality of training data and divides the plurality of training data into a plurality of subsets, a generation unit that includes a generation model that outputs pseudo data, a discrimination unit that includes a discrimination model that discriminates whether the input data is either the training data or the pseudo data according to an input of either the training data or the pseudo data, a management unit that sets a first hyperparameter to be used for updating the discrimination model based on a preset hyperparameter, and sets a second hyperparameter to be used for updating the generation model according to the number of GPUs for each server used for distribution processing, and a learning processing unit that updates the discrimination model using the first hyperparameter and updates the generation model using the second hyperparameter.

A learning method according to an aspect of the present disclosure including acquiring a data set including a plurality of training data, dividing a plurality of the training data into a plurality of subsets, generating pseudo data using a generation model that outputs the pseudo data, discriminating whether input data is the training data or the pseudo data by using a discrimination model that discriminates whether the input data is the training data or the pseudo data according to an input of either the training data or the pseudo data, setting a first hyperparameter to be used for updating the discrimination model based on a preset hyperparameter, setting a second hyperparameter to be used for updating the generation model based on the preset hyperparameter according to a number of GPUs for each server used for distribution processing, updating the discrimination model using the first hyperparameter, and updating the generation model using the second hyperparameter.

A program according to an aspect of the present disclosure causes a computer to execute acquiring a data set including a plurality of training data, dividing a plurality of the training data into a plurality of subsets, generating pseudo data using a generation model that outputs the pseudo data, discriminating whether input data is the training data or the pseudo data by using a discrimination model that discriminates whether the input data is the training data or the pseudo data according to an input of either the training data or the pseudo data, setting a first hyperparameter to be used for updating the discrimination model based on a preset hyperparameter, setting a second hyperparameter to be used for updating the generation model based on the preset hyperparameter according to a number of GPUs for each server used for distribution processing, updating the discrimination model using the first hyperparameter, and updating the generation model using the second hyperparameter.

### BRIEF DESCRIPTION OF THE DRAWINGS

Exemplary features and advantages of the present invention will become apparent from the following detailed description when taken with the accompanying drawings in which:

FIG. 1 is a block diagram illustrating an example of a configuration of a learning device according to the present disclosure;

FIG. 2 is a flowchart for explaining an example of learning processing by a learning device according to the present disclosure;

FIG. 3 is a flowchart for explaining an example of first update processing by a learning device according to the present disclosure;

FIG. 4 is a flowchart for explaining an example of second update processing by a learning device according to the present disclosure;

FIG. 5 is a block diagram illustrating an example of a configuration of a data augmentation system according to the present disclosure;

FIG. 6 is a conceptual diagram for explaining a target motion related to time-series skeleton data to be augmented by a data augmentation system according to the present disclosure;

FIG. 7 is a conceptual diagram for explaining skeleton data included in time-series skeleton data to be augmented by a data augmentation system according to the present disclosure;

FIG. 8 is a flowchart for explaining an example of data augmentation processing by a data augmentation system according to the present disclosure;

FIG. 9 is a flowchart for explaining an example of information separation processing by a data augmentation system according to the present disclosure;

FIG. 10 is a flowchart for explaining an example of augmentation processing by a data augmentation system according to the present disclosure;

FIG. 11 is a block diagram illustrating an example of a configuration of an estimation device according to the present disclosure;

FIG. 12 is a conceptual diagram illustrating a display example of motion data estimated by an estimation device according to the present disclosure;

FIG. 13 is a block diagram illustrating an example of a configuration of a learning device according to the present disclosure; and

FIG. 14 is a block diagram illustrating an example of a hardware configuration that executes processing according to the present disclosure.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

### First Example Embodiment

First, a learning device according to a first example embodiment will be described with reference to the drawings. The learning device of the present example embodiment is used for training a model used for data augmentation. For example, the learning device of the present example embodiment trains a model (generation model, estimation model) that generates augmentation data using actually measured motion data. The motion data is data indicating a change in posture according to the motion of the person. The motion data is extracted from a plurality of frames constituting the moving image. The method of the present example embodiment can be used to augment not only motion data but also arbitrary data.

### (Configuration)

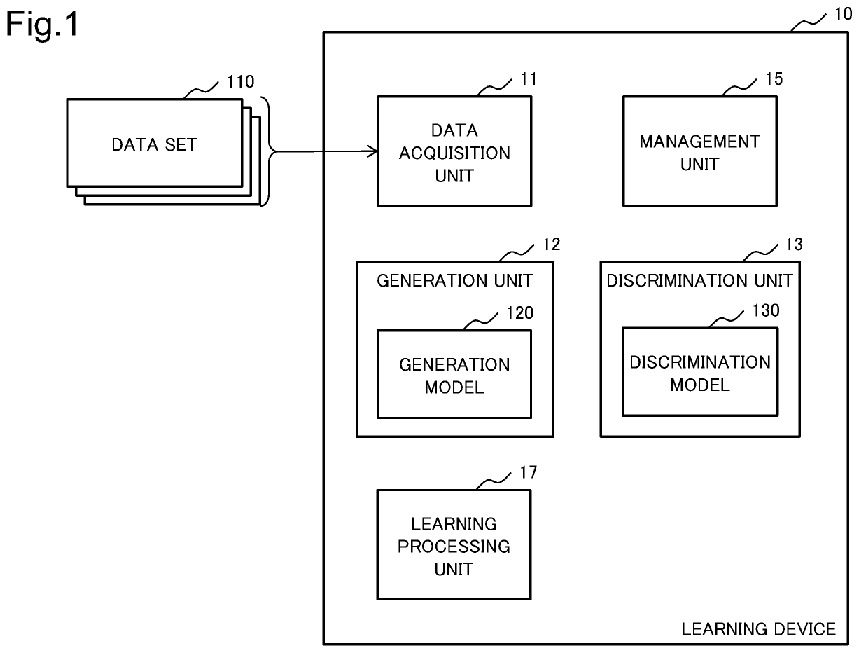

FIG. 1 is a block diagram illustrating an example of a configuration of a learning device 10 according to the present example embodiment. The learning device 10 includes a data acquisition unit 11, a generation unit 12, a discrimination unit 13, and a learning processing unit 17. In FIG. 1, lines indicating connections between components are omitted.

The data acquisition unit 11 acquires a data set 110 including a plurality of pieces of data (training data). The plurality of pieces of data constituting the data set 110 is not particularly limited. For example, the data set 110 includes a plurality of pieces of actual data actually measured. For example, the data set 110 is motion data extracted from the actually measured motion of the subject. For example, the data set 110 includes a plurality of pieces of data obtained by actually measuring a specific motion performed by a small number of subjects of about 10 persons by motion capture or the like. A plurality of pieces of data constituting the data set 110 needs to be actually measured. Therefore, it is difficult to prepare a large amount of a plurality of pieces of data constituting the data set 110.

The data acquisition unit 11 divides a plurality of pieces of data constituting the data set 110 into mini-batches. The mini-batch is a subset including a plurality of pieces of data included in the data set 110. The number of pieces of data included in the mini-batch is referred to as a batch size. For example, the batch size is set to 2 raised to the power of n (n is a natural number). The plurality of pieces of data divided into the mini-batches are used for determination by a discrimination model 130 of the discrimination unit 13. The division of the plurality of pieces of data constituting the data set 110 may be executed by a management unit 15 or the learning processing unit 17.

The generation unit 12 includes a generation model 120. In the present example embodiment, the generation model 120 is a target of learning by the learning device 10. The generation model 120 is a model that generates pseudo data. For example, the generation model 120 outputs pseudo data relevant to a random number value. The generation unit 12 generates pseudo data using the generation model 120. A method for generating pseudo data by the generation model 120 is not particularly limited. For example, the generation model 120 may generate pseudo data using noise according to a normal distribution.

The discrimination unit 13 includes a discrimination model 130. In the present example embodiment, the discrimination model 130 is not a target of learning by the learning device 10, but is secondarily trained. The discrimination model 130 is a model that discriminates whether the input data is training data or pseudo data. The discrimination unit 13 acquires the pseudo data generated by the generation unit 12. The discrimination unit 13 discriminates whether the acquired data is training data or pseudo data by using the discrimination model 130. The discrimination unit 13 outputs a discrimination result by the discrimination model 130 to the management unit 15.

The discrimination unit 13 calculates discrimination loss according to the discrimination result. The discrimination loss indicates the degree of discrimination error by the discrimination model 130. That is, the discrimination loss indicates the degree to which the discrimination result of the training data and the pseudo data by the discrimination model 130 is wrong. The discrimination loss indicates a ratio at which the training data is discriminated as the pseudo data and the pseudo data is discriminated as the training data with respect to all the training data and the pseudo data discriminated by the discrimination model 130. When the discrimination by the discrimination model 130 is all correct, the discrimination loss is 0. On the other hand, when all the discrimination by the discrimination model 130 is incorrect, the discrimination loss is 1.

The discrimination unit 13 calculates the generation loss according to the discrimination result. The generation loss indicates the degree to which the pseudo data generated by the generation model 120 is recognized as training data by the discrimination model 130. That is, the generation loss indicates the degree to which the pseudo data generated by the generation model 120 is discriminated as the pseudo data by the discrimination model 130. The generation loss indicates a ratio at which the pseudo data is discriminated as the pseudo data with respect to all the training data and the pseudo data discriminated by the discrimination model 130. When all the pieces of pseudo data generated by the generation model 120 are discriminated as training data by the discrimination model 130, the generation loss is 0. On the other hand, when all the pieces of pseudo data generated by the generation model 120 are determined as pseudo data by the discrimination model 130, the generation loss is 1.

The management unit 15 sets different learning rates for the discrimination model 130 and the generation model 120. The learning rate is a hyperparameter representing how much a weight, which is one of adjustable parameters, is changed at a time in machine learning optimization. As the adjustable parameter, a bias or a scaling coefficient may be used. In machine learning, weights are iteratively changed. As the value of the learning rate increases, the magnitude of the weight changed at a time increases, and thus the speed of learning increases. On the other hand, as the value of the learning rate decreases, the magnitude of the weight parameter to be changed at a time decreases, and thus the speed of learning is reduced. The management unit 15 sets the original learning rate (first learning rate) in the discrimination model 130 regardless of the number of GPUs for each server used for the distribution processing. On the other hand, the management unit 15 sets a learning rate (second learning rate) corresponding to the number of GPUs for each server used for the distribution processing in the generation model 120. That is, the management unit 15 sets a second hyperparameter (second learning rate) according to the number of GPUs for each server used for the distribution processing.

The management unit 15 calculates the parameters of the discrimination model 130 based on the discrimination loss using a first learning rate η₁. For example, the first learning rate η₁ is expressed by using the following Expression 1.

$$\begin{matrix}[ Math . 1 ] & \\ {η}_{1} = η & ( 1 )\end{matrix}$$

In the above Expression 1, η is a preset learning rate. In the example of Expression 1 described above, the management unit 15 sets the value of the preset hyperparameter (learning rate η) to a first hyperparameter (first learning rate η₁).

The management unit 15 calculates the parameter of the generation model 120 based on the generation loss using a second learning rate η₂. For example, the second learning rate η₂ is expressed by using the following Expression 2.

$$\begin{matrix}[ Math . 2 ] & \\ {η}_{1} = M \times η & ( 2 )\end{matrix}$$

In Expression 2 above, M is a product of the number of GPUs for each server used for distribution processing and the number of distribution processing. The number of distribution processing refers to the number of servers used for distribution processing. The number of pieces of data used to update the adjustable parameter of the discrimination model 130 or the generation model 120 once is referred to as a batch size. The batch size is proportional to M. In the example of Expression 2 described above, the management unit 15 sets a product of a preset hyperparameter (learning rate n) and M (a product of the number of GPUs and the number of distribution processing) as the second hyperparameter (second learning rate η₂).

As described above, the management unit 15 calculates the first learning rate η₁ of the discrimination model 130 and the second learning rate η₂ of the generation model 120. The hyperparameter may be other than the learning rate. For example, the hyperparameter may be a moment, an attenuation rate, or a batch size. For example, the hyperparameter may be the number of layers of the neural network or the number of neurons of each layer constituting the neural network. That is, the management unit 15 calculates the hyperparameter (first hyperparameter) of the discrimination model 130 and the hyperparameter (second hyperparameter) of the generation model 120.

Different learning rates may be set for the discrimination model 130 and the generation model 120. For example, the management unit 15 calculates the first learning rate η₁ and the second learning rate 12 using the following Expressions 3 and 4.

$$\begin{matrix}[ Math . 3 ] & \\ {η}_{1} = {η}_{d} & ( 3 )\end{matrix}$$

$$\begin{matrix}[ Math . 4 ] & \\ {η}_{2} = M \times {η}_{g} & ( 4 )\end{matrix}$$

In the above Expressions 3 and 4, η_{d} is a first learning rate set in advance for the discrimination model 130. η_{g} is a second learning rate set in advance for the generation model 120.

In the example of Expression 3 above, the management unit 15 sets the value of the hyperparameter (learning rate η_{d}) set in advance for the discrimination model 130 to the first hyperparameter (first learning rate η₁). On the other hand, in the example of Expression 4 described above, the management unit 15 sets the product of the hyperparameter (learning rate η_{g}) set in advance for the generation model 120 and the number M of GPUs as the second hyperparameter (second learning rate η₂).

For example, in the motion data generation, the second learning rate η₂ may be set to about four times the first learning rate η₁. For example, in a case where a single GPU (M=1) is used as the number of GPUs, the batch size is 32, η_{d} is 0.0002, and η_{g} is 0.0008. When the same learning is executed by 8 GPUs (M=8), the batch size is 256, η_{d} is 0.0002, and η_{g} is 0.0064.

For example, the management unit 15 may calculate the second learning rate η₂ using the following Expression 5.

$$\begin{matrix}[ Math . 5 ] & \\ {η}_{2} = \sqrt{M} \times {η}_{g} & ( 5 )\end{matrix}$$

The example using the above Expression 5 indicates that the method of the present example embodiment can be applied not only to linear scaling but also to nonlinear scaling.

In the example of Expression 5 described above, the management unit 15 sets the product of the hyperparameter (learning rate η_{g}) set in advance for the generation model 120 and the value output from the monotonically increasing function according to the input of the number M of GPUs as the second hyperparameter (second learning rate η₂).

In more general expression, the first learning rate η₁ and the second learning rate η₂ are expressed using the following Expressions 6 and 7.

$$\begin{matrix}[ Math . 6 ] & \\ {η}_{1} = f ( M ) \times {η}_{d} & ( 6 )\end{matrix}$$

$$\begin{matrix}[ Math . 7 ] & \\ {η}_{2} = g ( M ) \times {η}_{g} & ( 7 )\end{matrix}$$

In Expressions 6 and 7 above, f(M) and g(M) represent functions that change according to the number M of GPUs. For example, f(M) and g(M) are monotonically increasing functions such as an exponential function, a logarithmic function, and an irrational function. That is, f(M) and g(M) are monotonically increasing functions that change according to the number M of GPUs.

The learning processing unit 17 updates the generation model 120 and the discrimination model 130 using the hyperparameter calculated by the management unit 15. The learning processing unit 17 updates parameters such as a weight and a bias of the discrimination model 130 by using the first learning rate η₁ calculated for the discrimination model 130. That is, the learning processing unit 17 updates the parameters of the discrimination model 130 using the first hyperparameter. The learning processing unit 17 updates the parameters such as the weight and the bias of the generation model 120 using the second learning rate 12 calculated for the generation model 120. That is, the learning processing unit 17 updates the parameters of the generation model 120 using the second hyperparameter. The learning processing unit 17 trains the discrimination model 130 and the generation model 120 whose parameters have been updated. The generation model 120 trained by the learning processing unit 17 is used for data augmentation. For example, the learning processing unit 17 calculates a derivative of the loss according to the calculated value of the loss. The learning processing unit 17 updates the generation model 120 and the discrimination model 130 by multiplying the calculated slope by the learning rate. The learning processing unit 17 trains the generation model 120 and the discrimination model 130 so that the loss is directed to the optimum solution.

### (Operation)

Next, an example of the operation of the learning device 10 will be described with reference to the drawings. Hereinafter, the learning processing by the learning device 10 and the update processing included in the learning processing will be separately described. The update processing will be described separately for first update processing of updating the parameter of the discrimination model 130 and second parameter update processing of updating the parameter of the generation model 120.

### [Learning Processing]

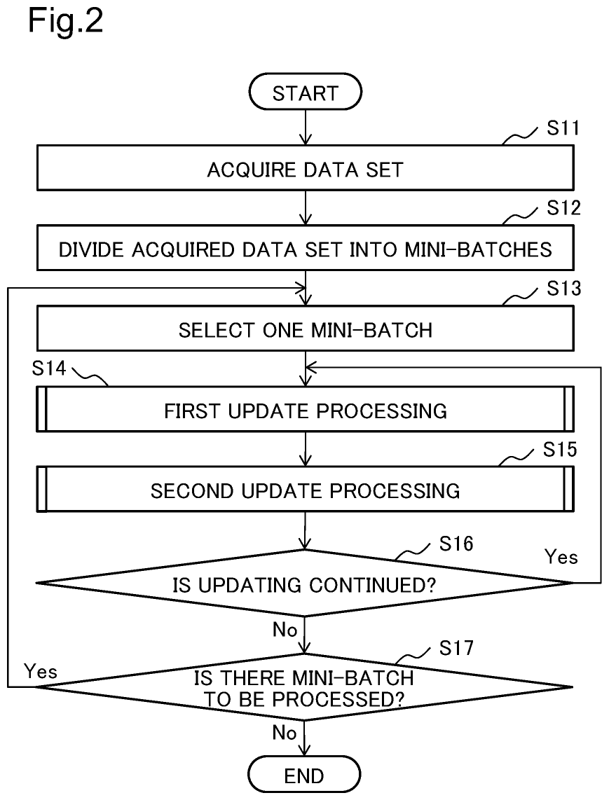

FIG. 2 is a flowchart for explaining an example of learning processing by the learning device 10. In the description along the flowchart of FIG. 2, the learning device 10 will be described as an operation subject.

In FIG. 2, first, the learning device 10 acquires a data set 110 (step S11). The plurality of pieces of data constituting the data set 110 is training data actually measured for the subject. The data set 110 may include separately generated pseudo data.

Next, the learning device 10 divides a plurality of pieces of data constituting the acquired data set 110 into mini-batches (step S12).

Next, the learning device 10 selects one mini-batch (step S13).

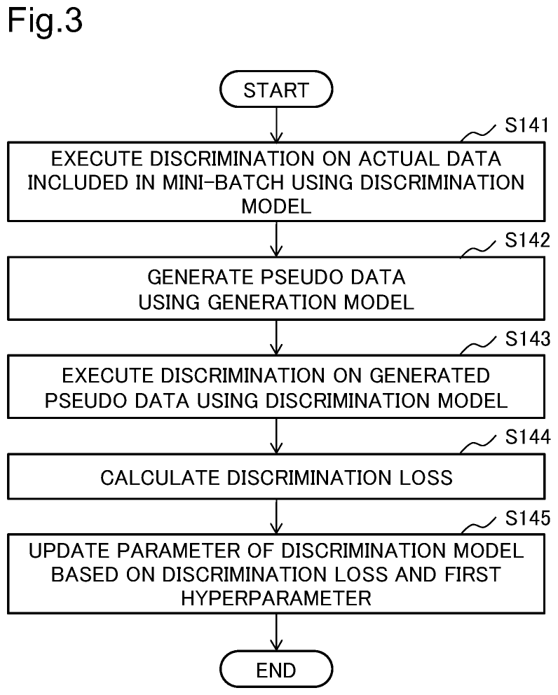

Next, the learning device 10 executes the first update processing on the selected mini-batch (step S14). The first update processing is a process of updating the parameters of the discrimination model 130 based on the first learning rate. Details of the first update processing will be described later (FIG. 3).

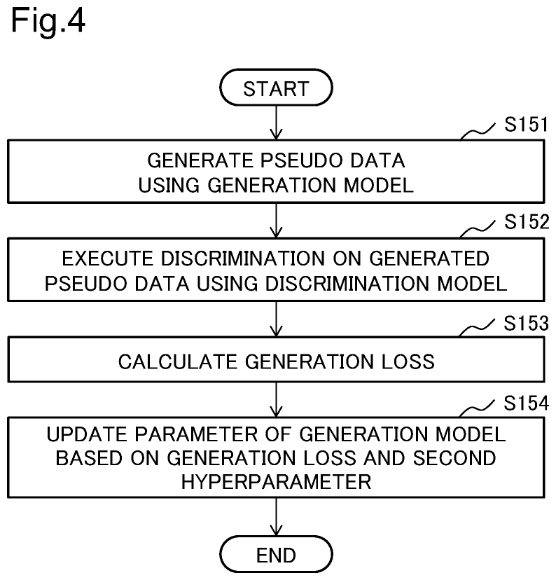

Next, the learning device 10 executes second update processing (step S15). The second update processing is a process of updating the parameter of the generation model 120 based on the second learning rate. Details of the second update processing will be described later (FIG. 4).

When the update of the generation model 120 and the discrimination model 130 is continued (Yes in step S16), the flow returns to step S14. The continuation of the update may be determined based on a predetermined criterion, or may be determined in accordance with an input operation by the administrator making a decision. For example, the update of the generation model 120 and the discrimination model 130 is repeated for a preset number of epochs. For example, the number of epochs is set to 10,000. In a case where the update of the generation model 120 and the discrimination model 130 is not continued (No in step S16), if there is a mini-batch to be processed (Yes in step S17), the flow returns to step S13. When there is no mini-batch to be processed (No in step S17), the processing according to the flowchart of FIG. 2 is ended.

### [First Update Processing]

Next, details of the first update processing (step S14 in the flowchart of FIG. 2) will be described with reference to the drawings. FIG. 3 is a flowchart for explaining the first update processing. In the description along the flowchart of FIG. 3, the learning device 10 will be described as an operation subject.

In FIG. 3, first, the learning device 10 executes discrimination on the training data included in the mini-batch using the discrimination model 130 (step S141).

Next, the learning device 10 generates pseudo data using the generation model 120 (step S142). The order of steps S141 and S142 may be switched, or may be executed in parallel.

Next, the learning device 10 executes discrimination on the generated pseudo data using the discrimination model 130 (step S143).

Next, the learning device 10 calculates a discrimination loss according to the execution result of the discrimination model 130 (step S144).

Next, the learning device 10 updates the parameters of the discrimination model 130 based on the calculated discrimination loss and hyperparameter (step S145). For example, the learning device 10 updates the parameter of the discrimination model based on the discrimination loss and the first learning rate. After step S145, the flow proceeds to the second update processing (step S15 in the flowchart of FIG. 2). Details of the second update processing will be described later (FIG. 4).

### [Second Update Processing]

Next, details of the second update processing (step S15 in the flowchart of FIG. 2) will be described with reference to the drawings. FIG. 4 is a flowchart for explaining the second update processing. In the description along the flowchart of FIG. 4, the learning device 10 will be described as an operation subject.

In FIG. 4, first, the learning device 10 generates pseudo data using the generation model 120 (step S151).

Next, the learning device 10 executes discrimination on the generated pseudo data using the discrimination model 130 (step S152).

Next, the learning device 10 calculates a generation loss according to the execution result of the discrimination model 130 (step S153).

Next, the learning device 10 updates the parameter of the discrimination model based on the calculated generation loss and hyperparameter (step S145). For example, the learning device 10 updates the parameter of the generation model 120 based on the discrimination loss and the second learning rate. After step S154, the flow proceeds to step S16 of the flowchart of FIG. 2.

As described above, the learning device according to the present example embodiment includes the data acquisition unit, the generation unit, the discrimination unit, the management unit, and the learning processing unit. The data acquisition unit acquires a data set including a plurality of training data. The data acquisition unit divides the plurality of training data into a plurality of subsets. The generation unit includes a generation model. The generation model outputs pseudo data. The discrimination unit includes a discrimination model. The discrimination model discriminates whether the input data is training data or pseudo data according to the input of either the training data or the pseudo data. The discrimination unit calculates a discrimination loss indicating the degree of a discrimination error by the discrimination model. The discrimination unit calculates a generation loss indicating the degree to which the pseudo data generated by the generation model is recognized as the pseudo data by the discrimination model. The management unit sets a first hyperparameter to be used for updating the discrimination model based on a preset hyperparameter. The management unit sets a second hyperparameter to be used for updating the generation model according to the number of GPUs for each server used for the distribution processing. The learning processing unit updates the parameter of the discrimination model based on the discrimination loss and the first hyperparameter. The learning processing unit updates the parameter of the generation model based on the generation loss and the second hyperparameter.

The learning device according to the present example embodiment updates the discrimination model and the generation model using different hyperparameters. The learning device according to the present example embodiment sets the second hyperparameter according to the number of GPUs. The learning device of the present example embodiment does not change the first hyperparameter according to the number of GPUs. That is, the learning device of the present example embodiment adjusts the learning rate of the generation model without changing the learning rate of the discrimination model according to the scale of the distributed learning. Therefore, according to the present example embodiment, even when the batch size exceeds the data set size, the generation model (estimation model) can be efficiently trained. That is, according to the present example embodiment, in a large-scale distributed learning environment, the minority shot learning of the GAN can be speeded up.

In a large-scale distributed learning environment, the precondition that the batch size is sufficiently smaller than the size of the entire data set, which is assumed by the linear scaling law that increases the learning rate according to the size of the batch size, is not satisfied. Therefore, in a large-scale distributed learning environment, it is difficult to speed up training even using the method of NPL 1 (P. Goyal. et al., “Accurate, Large Minibatch SGD: Training ImageNet in 1 Hour,” arXiv: 1706.02677, 2018). On the other hand, in the method of the present example embodiment, the second learning rate of the generation model is changed without changing the first learning rate of the discrimination model according to the size of the batch size. Therefore, according to the present example embodiment, it is possible to achieve both scale merit of distributed learning and acceleration of training.

The method of the present example embodiment is not limited to the GAN, and can be applied to other machine learning. According to the present example embodiment, it is possible to efficiently train a model by adjusting hyperparameters according to the scale of distributed learning. In particular, in the present example embodiment, the training of the model is made efficient by changing the learning rate in proportion to the number of GPUs.

In an aspect of the present example embodiment, the management unit sets a preset value of the hyperparameter as the first hyperparameter. The management unit sets the product of the preset hyperparameter and the number of GPUs as the second hyperparameter. According to the present aspect, by setting the product of the preset hyperparameter and the number of GPUs as the second hyperparameter, the minority shot learning of the GAN can be speeded up even in a large-scale distributed learning environment.

In an aspect of the present example embodiment, the management unit sets a preset value of the hyperparameter for the discrimination model as the first hyperparameter. The management unit sets the product of a hyperparameter preset for the generation model and the number of GPUs as the second hyperparameter. In the present aspect, the product of the preset hyperparameter and the value output from the monotonically increasing function according to the input of the number of GPUs is set as the second hyperparameter. That is, according to the present aspect, by adjusting the second hyperparameter by the nonlinear scaling, the minority shot learning of the GAN can be speeded up even in a large-scale distributed learning environment.

In an aspect of the present example embodiment, the hyperparameter is a learning rate. The second learning rate corresponding to the second hyperparameter is larger than the first learning rate corresponding to the first hyperparameter. According to the present aspect, it is possible to speed up the minority shot learning of the GAN even in a large-scale distributed learning environment based on the learning rate.

### Second Example Embodiment

Next, a data augmentation system according to a second example embodiment will be described with reference to the drawings. The data augmentation system of the present example embodiment augments the measured target data using the model (generation model) learned by the learning device of the first example embodiment. In the present example embodiment, an example of augmenting the time-series data (time-series skeleton data) of the target data actually measured according to the target motion of the subject will be described. For example, the target motion includes a specific motion such as stretching or jumping, walking, running, or stretching. The type of the target motion is not particularly limited as long as it can be reconstructed using source motion data to be described later. The data augmentation system of the present example embodiment augments target data actually measured according to target motions performed by a small number of subjects of about 10 persons.

### (Configuration)

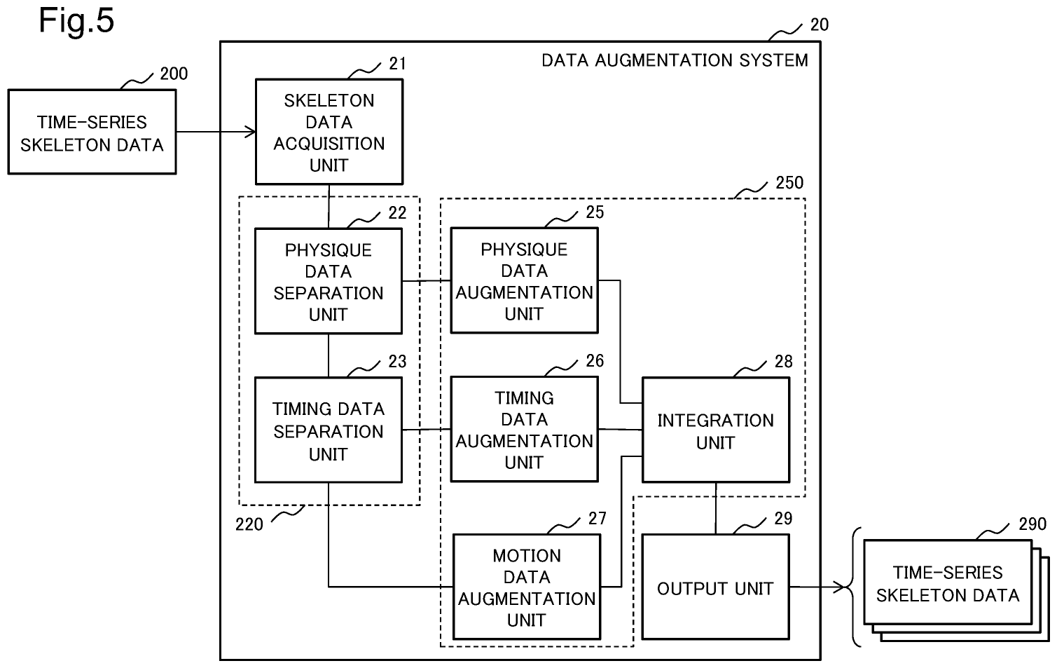

FIG. 5 is a block diagram illustrating an example of a configuration of a data augmentation system 20 according to the present example embodiment. The data augmentation system 20 includes a skeleton data acquisition unit 21, a physique data separation unit 22, a timing data separation unit 23, a physique data augmentation unit 25, a timing data augmentation unit 26, a motion data augmentation unit 27, an integration unit 28, and an output unit 29. The physique data separation unit 22 and the timing data separation unit 23 constitute an information separation device 220. The physique data augmentation unit 25, the timing data augmentation unit 26, the motion data augmentation unit 27, and the integration unit 28 constitute an augmentation device 250.

The skeleton data acquisition unit 21 acquires time-series skeleton data 200 to be augmented. The time-series skeleton data 200 includes time-series data of skeleton data extracted from moving image data actually measured for a subject (person) who performs a target motion. The skeleton data includes a three-dimensional position of the joint of the subject measured by motion capture or the like. The time-series skeleton data includes time-series data of skeleton data according to the motion of the subject. The time-series skeleton data 200 includes physique data of the subject. The physique data is information regarding the physique of the subject. The physique data relates to an attribute element of the subject. For example, the physique data includes information related to a length of a part such as an arm, a leg, a torso, and a shoulder width of the subject.

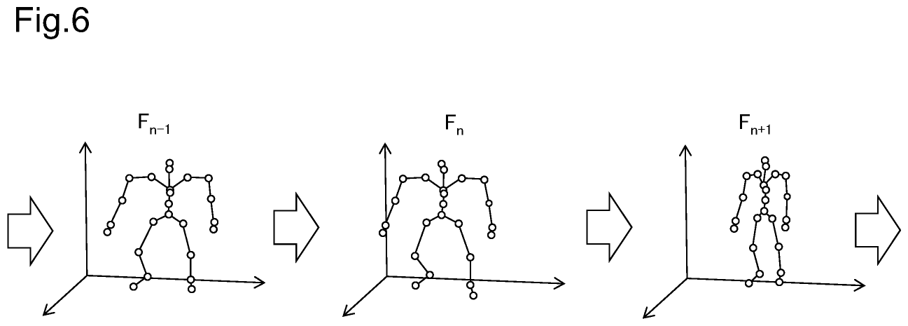

FIG. 6 is a conceptual diagram for explaining a target motion related to the time-series skeleton data 200. FIG. 6 is a diagram obtained by cutting out a motion of a person who performs a target motion. FIG. 6 illustrates target motions extracted from the frame Fₙ₋₁, the frame Fₙ, and the frame Fₙ₊₋₁ constituting the moving image (n is a natural number). The frame Fₙ₋₁, the frame Fₙ, and the frame Fₙ₊₁ are continuous frames. In each frame, circles indicating positions of representative parts of the person are connected by connection lines. For example, joints such as a shoulder, an elbow, a wrist, a neck, a chest, a waist, a crotch, a knee, and an ankle are selected as representative parts of the person. For example, ends such as a head, a fingertip, and a toe are selected as representative parts of the person. A region between joints and ends may be selected as a representative part of a person. Hereinafter, the position of a representative part of a person is expressed as a joint.

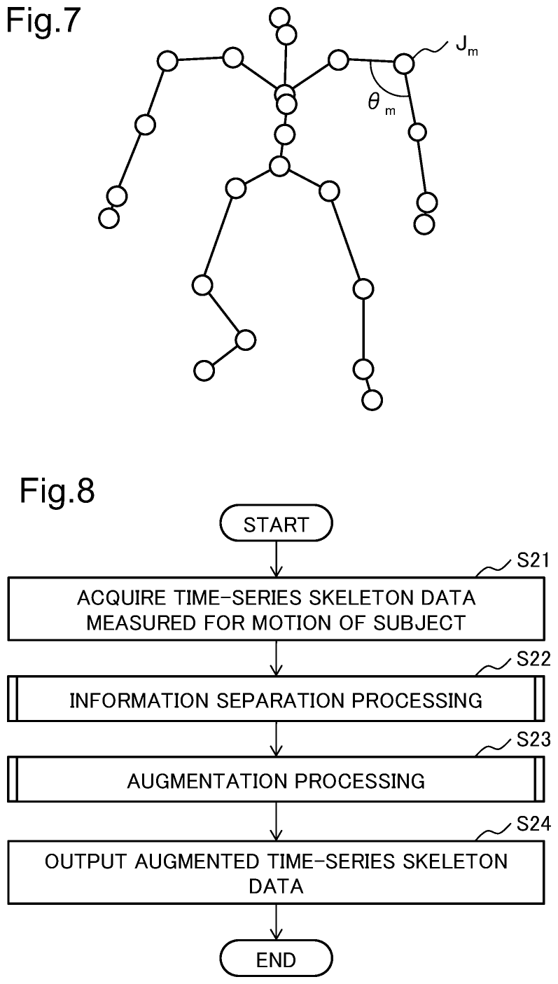

FIG. 7 is a conceptual diagram for explaining skeleton data included in the time-series skeleton data 200. In the present example embodiment, a three-dimensional joint angle (Euler angle θₘ) formed by two connection lines connected by the joint Jₘ is used as target data. The time-series skeleton data 200 is a data set in which angles formed by two connection lines connected to each of a plurality of joints are collected in time series. The format of the data used as the time-series skeleton data 200 is not particularly limited as long as the data can be used for the estimation of the target motion.

The physique data separation unit 22 separates the physique data of the subject from the time-series skeleton data 200.

The timing data separation unit 23 acquires timing data from the remaining time-series skeleton data from which the physique data has been separated. The timing data includes information on the time of the motion performed by the subject. The timing data relates to a time element of the motion performed by the subject. For example, the timing data includes information related to a walking cycle in walking of the subject, information related to jumping of the subject, and the like.

The time-series skeleton data from which the timing data is separated is set as motion data. The motion data relates to a change in posture during a motion performed by the subject. The individual skeleton data constituting the time-series skeleton data set in the motion data is also referred to as posture data. The posture data is a spatial element of the motion performed by the subject. A three-dimensional joint angle (Euler angle) extracted from the skeleton data is set in the motion data. The motion data may be data indicating a motion other than a three-dimensional joint angle (Euler angle).

The physique data augmentation unit 25 augments the physique data by changing the attribute element of the subject. For example, the physique data augmentation unit 25 augments the physique data by increasing variations regarding the length of parts such as an arm, a leg, a torso, and a shoulder width according to the attribute of the subject. The physique data augmentation unit 25 outputs a data set (augmented physique data set) of the augmented physique data to the integration unit 28.

For example, in a case where the subject is a male, the physique data augmentation unit 25 augments the physique data in accordance with an average value or distribution of lengths of parts related to the male. For example, the physique data augmentation unit 25 augments the physique data by changing the attribute of the subject and increasing variations in the length of the part. For example, in a case where the subject is a female, the physique data augmentation unit 25 augments the physique data in accordance with an average value or distribution of lengths of parts related to the male. For example, in a case where the subject is an adult, the physique data augmentation unit 25 augments the physique data in accordance with an average value or distribution of lengths of parts related to a child.

For example, the physique data augmentation unit 25 may augment the physique data by changing the nationality of the subject and increasing variations in the length of the part. For example, in a case where the nationality of the subject is Japan, the physique data augmentation unit 25 augments the physique data according to the average value or distribution of the lengths of parts related to a person whose nationality is US.

The timing data augmentation unit 26 augments the timing data by changing a time element of the motion performed by the subject. For example, the timing data augmentation unit 26 augments the timing data by increasing variations related to the time element of the motion performed by the subject. The timing data augmentation unit 26 outputs a data set (augmented timing data set) of the augmented timing data to the integration unit 28.

For example, the timing data augmentation unit 26 augments the timing data by varying the ratio of the swing phase or the stance phase in the walking cycle detected from the walking of the subject. For example, the timing data augmentation unit 26 augments the timing data by changing the interval of walking events such as heel strike, heel raising, toe off, foot adjacent, and tibial vertical detected from walking of the subject. For example, the timing data augmentation unit 26 augments the timing data in accordance with the average value or variance of persons having the same attribute as the subject. For example, the timing data augmentation unit 26 augments the timing data in accordance with the average value or variance of persons having the attribute different from the subject.

The motion data augmentation unit 27 augments the motion data. The motion data augmentation unit 27 augments the motion data by increasing variations of the plurality of posture data constituting the motion data. The motion data augmentation unit 27 outputs a data set (augmented motion data set) of the augmented motion data to the integration unit 28.

For example, the motion data augmentation unit 27 augments the motion data using the model (generation model) learned by the learning device according to the first example embodiment. In that case, the motion data augments motion data related to three-dimensional joint angles (Euler angles). The motion data augmentation unit 27 may augment the motion data using a model other than the generation model.

The integration unit 28 acquires the augmented physique data set, the augmented timing data set, and the augmented motion data set. The integration unit 28 integrates the data included in each of the acquired augmented physique data set, augmented timing data set, and augmented motion data set to augment the time-series skeleton data. The integration unit 28 augments the skeleton data by combining the augmented physique data, the augmented timing data, and the augmented motion data.

The output unit 29 outputs the augmented time-series skeleton data 290. For example, the augmented time-series skeleton data 290 is used for learning of a model for predicting the motion of the subject. The application of the augmented time-series skeleton data 290 is not particularly limited.

### (Operation)

Next, an example of the operation of the data augmentation system 20 of the present example embodiment will be described with reference to the drawings. Hereinafter, data augmentation processing by the data augmentation system 20, and information separation processing and augmentation processing included in the data augmentation processing will be described.

FIG. 8 is a flowchart for explaining an example of the operation (data augmentation processing) of the data augmentation system 20. In the description along the flowchart of FIG. 8, the data augmentation system 20 will be described as an operation subject.

In FIG. 8, first, the data augmentation system 20 acquires time-series skeleton data measured for the subject who has performed the target motion (step S21).

Next, the data augmentation system 20 executes information separation processing to separate the time-series skeleton data into the physique data, the timing data, and the motion data (step S22).

Next, the data augmentation system 20 executes augmentation processing to augment each of the physique data, the timing data, and the motion data (step S23).

Next, the data augmentation system 20 outputs the augmented time-series skeleton data (step S24). The augmented time-series skeleton data is used for various applications. For example, the augmented time-series skeleton data is used for learning of a model for predicting the motion of the subject.

### [Information Separation Processing]

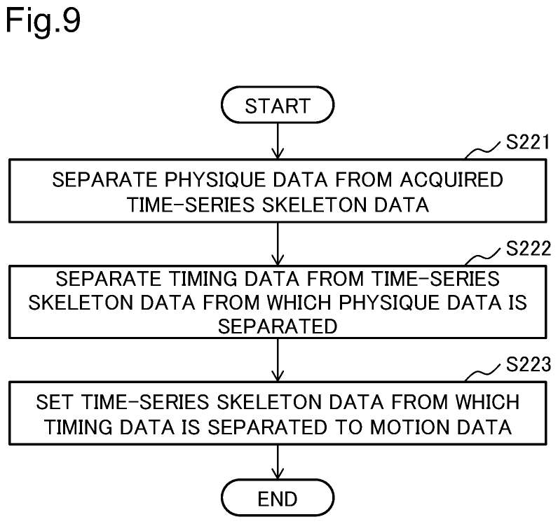

FIG. 9 is a flowchart for explaining an example of the information separation processing (step S22 in FIG. 8) included in the data augmentation processing by the data augmentation system 20. In the description along the flowchart of FIG. 9, the information separation device 220 included in the data augmentation system 20 will be described as an operation subject.

In FIG. 9, first, the information separation device 220 separates the physique data from the acquired time-series skeleton data (step S221). The separated physique data is used for data augmentation by the augmentation device 250 included in the data augmentation system 20.

Next, the information separation device 220 separates the timing data from the time-series skeleton data from which the physique data is separated (step S222). The separated timing data is used for data augmentation by the augmentation device 250 included in the data augmentation system 20.

Next, the information separation device 220 sets the time-series skeleton data from which the timing data is separated as the motion data (step S223). After step S223, the process proceeds to the augmentation processing in step S23 in FIG. 8. The set motion data is used for data augmentation by the augmentation device 250 included in the data augmentation system 20.

### [Data Augmentation Processing]

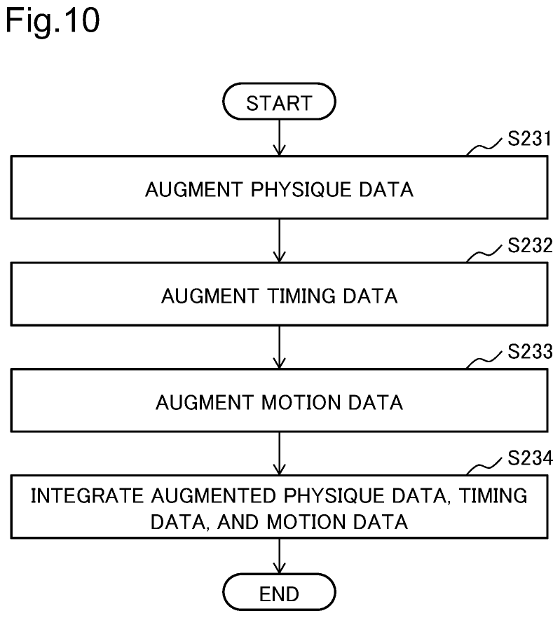

FIG. 10 is a flowchart for explaining an example of augmentation processing (step S23 in FIG. 8) included in the data augmentation processing by the data augmentation system 20. In the description along the flowchart of FIG. 10, the augmentation device 250 included in the data augmentation system 20 will be described as an operation subject.

In FIG. 10, first, the augmentation device 250 augments the physique data (step S231). The augmented physique data constitutes an augmented physique data set.

Next, the augmentation device 250 augments the timing data (step S232). The augmented timing data constitutes an augmented timing data set.

Next, the augmentation device 250 augments the motion data (step S233). The augmented motion data constitutes an augmented motion data set.

Next, the augmentation device 250 augments the time-series skeleton data by integrating the data included in each of the augmented physique data set, the augmented timing data set, and the motion data (step S234). After step S234, the process proceeds to step S24 in FIG. 8.

As described above, the data augmentation system of the present example embodiment augments the motion data (time-series skeleton data) using the generation model learned by a first learning device. The data augmentation system according to the present example embodiment includes an information separation device and an augmentation device. The information separation device acquires time-series skeleton data measured according to the motion of the person. The information separation device separates physique data, timing data, and motion data from the time-series skeleton data. The physique data is data related to an attribute element of a person. The timing data is data related to a time element of the action performed by a person. The motion data is data related to a change in posture during a motion performed by a person. The augmentation device augments each of the physique data, the timing data, and the motion data. The augmentation device augments the time-series skeleton data by integrating the augmented physique data, timing data, and motion data. The augmentation device augments the motion data using the generation model. Data Augmentation System The augmentation device outputs the augmented time-series skeleton data.

The data augmentation system of the present example embodiment individually augments each of the physique data, the timing data, and the motion data. The data augmentation system of the present example embodiment augments the time-series skeleton data by combining and integrating the individually augmented physique data, timing data, and motion data. The data augmentation system according to the present example embodiment can provide a wide variety of time-series skeleton data regarding the attribute of the person, the time element of the motion performed by the person, and the change in posture during the motion performed by the person. Therefore, according to the present example embodiment, it is possible to augment the time-series skeleton data applicable to learning of the motions of various persons using a small amount of motion data.

In one aspect of the present example embodiment, the information separation device includes a physique data separation unit and a timing data separation unit. The physique data separation unit separates the physique data from the time-series skeleton data. The timing data separation unit separates the timing data from the time-series skeleton data from which the physique data is separated. The time-series skeleton data in which the physique data and the timing data are separated is the motion data. The augmentation device includes a physique data augmentation unit, a timing data augmentation unit, a motion data augmentation unit, and an integration unit. The physique data augmentation unit changes the attribute element to augment the physique data. The timing data augmentation unit augments the timing data by changing a time element. The motion data augmentation unit augments the motion data by generating pseudo motion data output from the estimation model in response to the input of the motion data. The integration unit integrates the augmented physique data, timing data, and motion data to augment the time-series skeleton data. In the present aspect, the attribute element is changed to increase the variation of the physique data, and the time element is changed to increase the timing data. In the present aspect, the pseudo motion data is generated using the estimation model trained with a small amount of motion data. According to the present aspect, it is possible to augment the time-series skeleton data applicable to learning of motions of various persons using a small amount of motion data.

### Third Example Embodiment

Next, an estimation device according to a third example embodiment will be described with reference to the drawings. The estimation device of the present example embodiment uses an estimation model learned using the time-series skeleton data augmented by the data augmentation system of the second example embodiment. The estimation device according to the example embodiment generates motion data (estimation data) based on motion data actually measured by using the estimation model. The estimation device of the present example embodiment may be configured to use an estimation model learned using the motion data augmented by the data augmentation system of the second example embodiment. In the present example embodiment, an example of estimating the time-series skeleton data (estimation data) related to the motion of the subject using the time-series skeleton data (actual data) actually measured according to the target motion of the subject will be described.

### (Configuration)

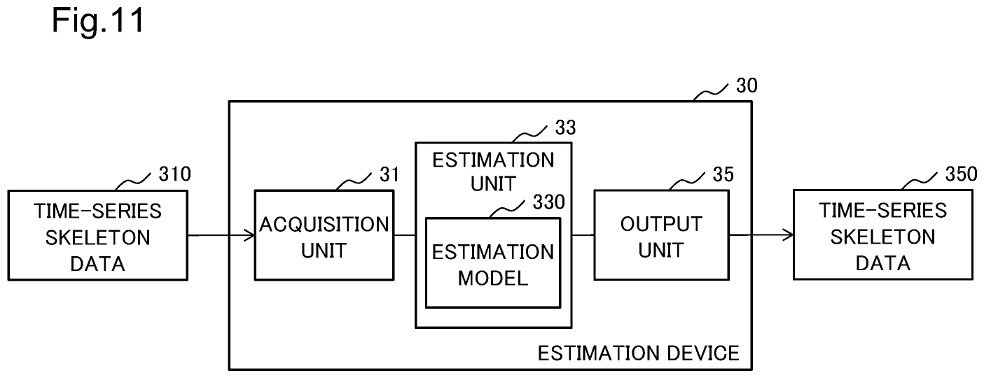

FIG. 11 is a block diagram illustrating an example of a configuration of an estimation device 30. The estimation device 30 includes an acquisition unit 31, an estimation unit 33, and an output unit 35.

The acquisition unit 31 acquires time-series skeleton data 310. The time-series skeleton data 310 is augmentation target data. For example, the time-series skeleton data 310 is time-series skeleton data based on actual data measured regarding the motion of the subject. The skeleton data includes a three-dimensional position of the joint of the subject measured by motion capture or the like.

The estimation unit 33 includes an estimation model 330. The estimation model 330 is a model learned using time-series skeleton data augmented by the data augmentation system of the second example embodiment. The estimation model 330 outputs time-series skeleton data 350 (augmentation data) in response to the input of the time-series skeleton data 310 (augmentation target data). The estimation unit 33 inputs the time-series skeleton data 310 to the estimation model 330, and estimates the motion of the subject according to the time-series skeleton data 350 output from the estimation model 330.

The output unit 35 outputs the time-series skeleton data 350 estimated using the estimation model 330. The output destination and application of the time-series skeleton data 350 are not particularly limited. For example, the time-series skeleton data 350 is displayed on a screen that can be visually recognized by the subject. For example, the time-series skeleton data 350 is output to a terminal device used by a trainer who manages the exercise state of the subject, a care manager who manages the health state of the subject, or the like.

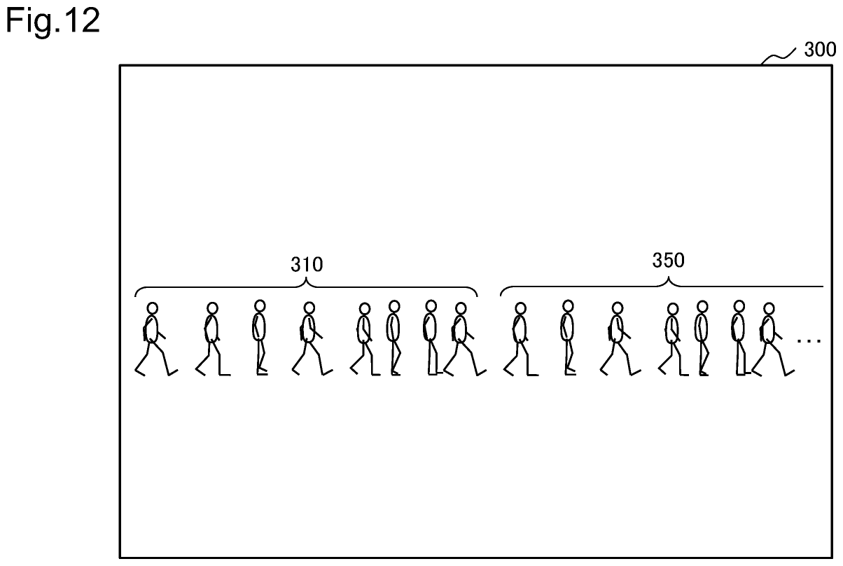

FIG. 12 illustrates an example in which the time-series skeleton data 350 estimated by the estimation device 30 is displayed on a screen 300 of the terminal device. On the screen 300, the time-series skeleton data 350 is displayed following the time-series skeleton data 310 measured regarding the walking of the subject. In the example of FIG. 12, a part of the skeleton is displayed with a minced image. For example, the skeleton may be fleshed or clothes or footwear may be worn using software. According to the present example embodiment, even if the subject does not actually continue walking, the future walking state of the subject can be estimated according to the walking state actually measured for the subject.

As described above, the estimation device of the present example embodiment estimates the motion of the person using the estimation model learned using the time-series skeleton data augmented by the data augmentation system of the second example embodiment. The estimation device according to the present example embodiment includes an acquisition unit, an estimation unit, and an output unit. The acquisition unit acquires actual data (time-series skeleton data) measured according to the motion of the person. The estimation unit estimates the motion of the person using the estimation data (time-series skeleton data) output from the estimation model according to the input of the actual data. The output unit outputs the estimated estimation data (time-series skeleton data).

The estimation device of the present example embodiment uses an estimation model learned using the time-series skeleton data augmented by the data augmentation system of the second example embodiment. The estimation model is a model trained so that motions of various persons can be estimated using a small amount of time-series skeleton data. Therefore, the estimation device of the present example embodiment can simulate the motions for various persons.

In the present example embodiment, an example is described in which the time-series skeleton data (estimation data) of the subject is estimated using the time-series skeleton data (actual data) actually measured according to the target motion of the subject. The information estimated by the estimation device of the present example embodiment is not limited to the time-series skeleton data. As an example, there is motion recognition for recognizing what motion the subject is performing. For example, by using the time-series skeleton data augmented by the data augmentation system of the third example embodiment, the estimation model can be learned by using a small amount of time-series skeleton data related to three motions of grasping, carrying, and placing objects. The estimation device of the present example embodiment can recognize the motions of grasping, carrying, and placing an object by using the estimation model. For example, the recognition result can be used for business visualization in distribution.

### Fourth Example Embodiment

Next, a learning device according to a fourth example embodiment will be described with reference to the drawings. The learning device of the present example embodiment has a configuration in which the learning device of the first example embodiment is simplified.

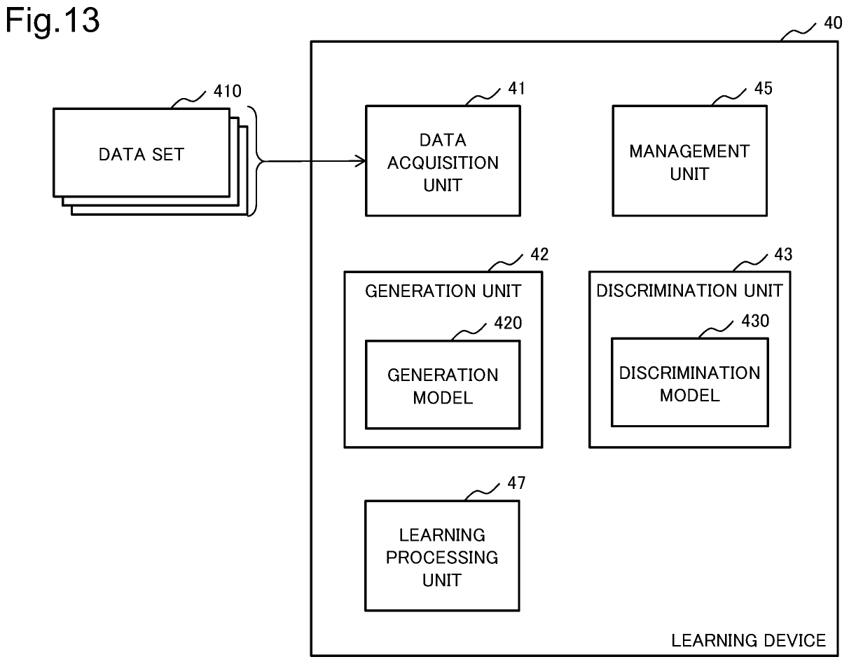

FIG. 13 is a block diagram illustrating an example of a configuration of a learning device 40 according to the present example embodiment. The learning device 40 includes a data acquisition unit 41, a generation unit 42, a discrimination unit 43, a management unit 45, and a learning processing unit 47.

The data acquisition unit 41 acquires a data set 410 including a plurality of training data. The data acquisition unit 41 divides the plurality of training data into a plurality of subsets. The generation unit 42 includes a generation model 420. The generation model 420 outputs pseudo data. The discrimination unit 43 includes a discrimination model 430. The discrimination model 430 discriminates whether the input data is the training data or the pseudo data according to the input of either the training data or the pseudo data. The management unit 45 sets a first hyperparameter to be used for updating the discrimination model based on a preset hyperparameter. The management unit 45 sets a second hyperparameter to be used for updating the generation model 420 according to the number of GPUs for each server used for the distribution processing. The learning processing unit 47 updates the discrimination model using the first hyperparameter and updates the generation model 420 using the second hyperparameter.

The learning device according to the present example embodiment updates the discrimination model and the generation model using different hyperparameters. The learning device according to the present example embodiment sets the second hyperparameter according to the number of GPUs for each server used for distribution processing. The learning device of the present example embodiment does not change the first hyperparameter according to the number of GPUs. That is, the learning device of the present example embodiment adjusts the learning rate of the generation model without changing the learning rate of the discrimination model according to the scale of the distributed learning. Therefore, according to the present example embodiment, even when the batch size exceeds the data set size, the generation model (estimation model) can be efficiently trained. That is, according to the present example embodiment, in a large-scale distributed learning environment, the minority shot learning of the GAN can be speeded up.

### (Hardware)

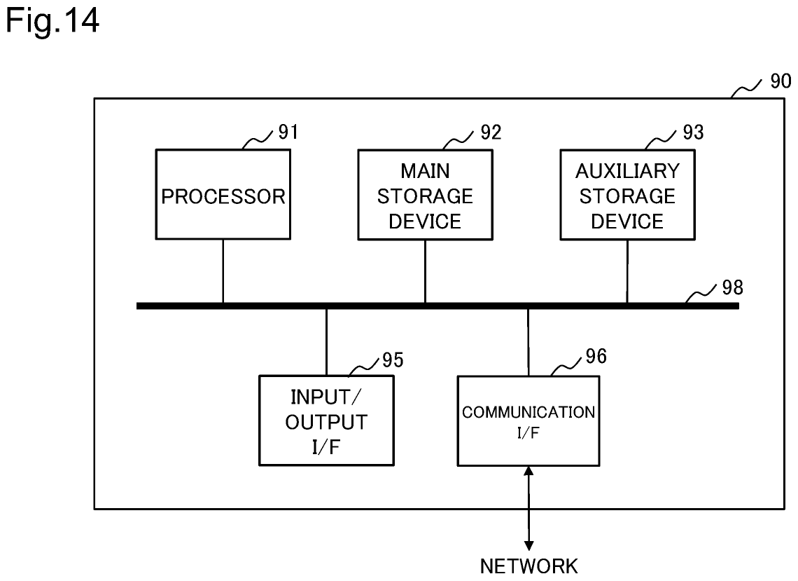

Next, a hardware configuration for executing control and processing according to each example embodiment of the present disclosure will be described with reference to the drawings. Here, an example of such a hardware configuration is an information processing device 90 (computer) in FIG. 14. The information processing device 90 in FIG. 14 is a configuration example for executing the control and processing of each example embodiment, and does not limit the scope of the present disclosure.

As illustrated in FIG. 14, the information processing device 90 includes a processor 91, a main storage device 92, an auxiliary storage device 93, an input/output interface 95, and a communication interface 96. In FIG. 14, the interface is abbreviated as an I/F. The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via the communication interface 96.

The processor 91 develops a program (instruction) stored in the auxiliary storage device 93 or the like in the main storage device 92. For example, the program is a software program for executing the control and processing of each example embodiment. The processor 91 executes the program developed in the main storage device 92. The processor 91 executes the control and processing according to each example embodiment by executing the program.

The main storage device 92 has an area in which a program is developed. A program stored in the auxiliary storage device 93 or the like is developed in the main storage device 92 by the processor 91. The main storage device 92 is implemented by, for example, a volatile memory such as a dynamic random access memory (DRAM). A nonvolatile memory such as a magneto resistive random access memory (MRAM) may be configured and added as the main storage device 92.

The auxiliary storage device 93 stores various data such as programs. The auxiliary storage device 93 is implemented by a local disk such as a hard disk or a flash memory. Various data may be stored in the main storage device 92, and the auxiliary storage device 93 may be omitted.

The input/output interface 95 is an interface for connecting the information processing device 90 and a peripheral device. The communication interface 96 is an interface for connecting to an external system or device through a network such as the Internet or an intranet based on a standard or a specification. The input/output interface 95 and the communication interface 96 may be shared as an interface connected to an external device.

An input device such as a keyboard, a mouse, or a touch panel may be connected to the information processing device 90 as necessary. These input devices are used to input information and settings. When a touch panel is used as the input device, a screen having a touch panel function serves as an interface. The processor 91 and the input device are connected via the input/output interface 95.

The information processing device 90 may be provided with a display device for displaying information. In a case where a display device is provided, the information processing device 90 may include a display control device (not illustrated) for controlling display of the display device. The display device may be connected to the information processing device 90 via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via an input/output interface 95.

The above is an example of the hardware configuration for enabling the control and processing according to each example embodiment of the present disclosure. The hardware configuration of FIG. 14 is an example of a hardware configuration for executing the control and processing of each example embodiment, and does not limit the scope of the present disclosure. A program for causing a computer to execute the control and processing according to each example embodiment is also included in the scope of the present disclosure.

Further, a program recording medium in which the program according to each example embodiment is recorded is also included in the scope of the present disclosure. The recording medium can be achieved by, for example, an optical recording medium such as a compact disc (CD) or a digital versatile disc (DVD). The recording medium may be implemented by a semiconductor recording medium such as a universal serial bus (USB) memory or a secure digital (SD) card. The recording medium may be implemented by a magnetic recording medium such as a flexible disk, or another recording medium. When a program executed by the processor is recorded in a recording medium, the recording medium is associated to a program recording medium.

The components of each example embodiment may be made in any combination. The components of each example embodiment may be implemented by software. The components of each example embodiment may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A learning device comprising:
a first memory storing first instructions, and
a first processor connected to the first memory and configured to execute the first instructions to:
acquire a data set including a plurality of training data and divides the plurality of training data into a plurality of subsets;
include a generation model that outputs pseudo data;
include a discrimination model that discriminates whether the input data is either the training data or the pseudo data according to an input of either the training data or the pseudo data;
set a first hyperparameter to be used for updating the discrimination model based on a preset hyperparameter, and sets a second hyperparameter to be used for updating the generation model according to the number of graphics processing units (GPUs) for each server used for distribution processing; and
update the discrimination model using the first hyperparameter and updates the generation model using the second hyperparameter.

2. The learning device according to claim 1, wherein
the first processor is configured to execute the first instructions to
calculate a discrimination loss indicating a degree of a discrimination error by the discrimination model,
calculate a generation loss indicating a degree of finding that the pseudo data generated by the generation model is the pseudo data by the discrimination model,
update a parameter of the discrimination model based on the discrimination loss and the first hyperparameter, and
update a parameter of the generation model based on the generation loss and the second hyperparameter.

3. The learning device according to claim 2, wherein
the first processor is configured to execute the first instructions to
set a value of the preset hyperparameter to the first hyperparameter; and
set a product of the preset hyperparameter and a number of the GPUs as the second hyperparameter.

4. The learning device according to claim 2, wherein
the first processor is configured to execute the first instructions to
set a value of the preset hyperparameter for the discrimination model as the first hyperparameter, and
set a product of the preset hyperparameter and a number of the GPUs for the generation model as the second hyperparameter.

5. The learning device according to claim 2, wherein
the first processor is configured to execute the first instructions to
set a product of the preset hyperparameter and a value output from a monotonically increasing function according to an input of a number of the GPUs as the second hyperparameter.

6. The learning device according to claim 1, wherein
the hyperparameter is a learning rate, and
a second learning rate corresponding to the second hyperparameter is larger than a first learning rate corresponding to the first hyperparameter.

7. A data augmentation system that augments motion data using a generation model learned by the learning device according to claim 1, the data augmentation system comprising:
an information separation device comprising:
a second memory storing second instructions, and
a second processor connected to the second memory and configured to execute the second instructions to:
acquire time-series skeleton data measured according to a motion of a person; and
separate, from the time-series skeleton data, physique data related to an attribute element of the person, timing data related to a time element of a motion performed by the person, and motion data related to a change in posture during a motion performed by the person; and
an augmentation device comprising:
a third memory storing third instructions, and
a third processor connected to the third memory and configured to execute the third instructions to:
augment each of the physique data, the timing data, and the motion data using the generation model,
augment the time-series skeleton data by integrating the augmented physique data, the timing data, and the motion data, and
output the augmented time-series skeleton data.

8. An estimation device that estimates a motion of a person using an estimation model learned using time-series skeleton data augmented by the data augmentation system according to claim 7, the estimation device comprising:
a fourth memory storing fourth instructions, and
a fourth processor connected to the fourth memory and configured to execute the fourth instructions to:
acquire actual data measured according to the motion of the person;
estimate estimation data output from the estimation model according to an input of the actual data as the motion of the person; and
output the estimation data.

9. A learning method causing a computer to execute:
acquiring a data set including a plurality of training data;
dividing a plurality of the training data into a plurality of subsets;
generating pseudo data using a generation model that outputs the pseudo data;
discriminating whether input data is the training data or the pseudo data by using a discrimination model that discriminates whether the input data is the training data or the pseudo data according to an input of either the training data or the pseudo data;
setting a first hyperparameter to be used for updating the discrimination model based on a preset hyperparameter;
setting a second hyperparameter to be used for updating the generation model based on the preset hyperparameter according to a number of graphics processing units (GPUs) for each server used for distribution processing;
updating the discrimination model using the first hyperparameter; and
updating the generation model using the second hyperparameter.

10. A non-transitory recording medium stored therein a program causing a computer to execute:
acquiring a data set including a plurality of training data;
dividing a plurality of the training data into a plurality of subsets;
generating pseudo data using a generation model that outputs the pseudo data;
determining whether input data is either the training data or the pseudo data by using a discrimination model that determines whether the input data is either the training data or the pseudo data according to an input of either the training data or the pseudo data;
setting a first hyperparameter to be used for updating the discrimination model based on a preset hyperparameter;
setting a second hyperparameter to be used for updating the generation model based on the preset hyperparameter according to a number of graphics processing units (GPUs) for each server used for distribution processing;
updating the discrimination model using the first hyperparameter; and
updating the generation model using the second hyperparameter.
